(19) United States
(12) Patent Application Publication
(10) Pub. No.: US 2025/0135784 A1
(43) Pub. Date: May 1, 2025

(54) INKJET PRINTER INCLUDING WIPER FOR WIPING HEAD EJECTION SURFACE

(71) Applicant: Roland DG Corporation, Hamamatsu-shi, Shizuoka (JP)

(72) Inventors: Hiroshi OKUNO, Hamamatsu-shi (JP); Akifumi ARAI, Hamamatsu-shi (JP)

(21) Appl. No.: 18/726,039

(22) PCT Filed: Jan. 21, 2022
(86) PCT No.: PCT/JP2022/002176

§ 371 Date: Jul. 1, 2024

(51) Int. Cl. B41J 2/165

(52) U.S. Cl. CPC B41J 2/16541; B41J 2/16505; B41J 2/16547

(57) ABSTRACT

An inkjet printer that can reduce abrasion of an absorber and a wiper with removal of wiper ink as much as possible, and can prevent adverse effects caused by abrasion powder thereof is provided. When a wiper at a standby position is lifted, an upper surface of the wiper is brought into contact with an absorber above the standby position, and wiper ink adhering to the upper surface of the wiper is absorbed by the absorber and removed. At this time, the wiper and the absorber are not rubbed against each other. Thus, abrasion of the wiper and the absorber can be reduced as much as possible.

### BACKGROUND OF THE INVENTION

### 1. Field of the Invention

The present invention relates to inkjet printers each including a wiper to wipe a head ejection surface, and in particular, to inkjet printers each including a wiper to wipe ink on an ejection surface on a head lower surface.

### 2. Description of the Related Art

An inkjet printer generally includes a head including ejection ports (nozzles) ejecting ink on a lower surface, and ejects the ink onto an upper surface of a sheet-shaped medium (printing medium) disposed below the head to perform printing. To perform high-precision printing, a state of the ink at the ejection ports, i.e., a so-called nozzle meniscus (ink liquid level), is important. For example, when unnecessary ink droplets adhere to the ejection ports, flight deflection and landing deviation of the ejected ink droplets, shape defects of ink dots after landing, and the like occur. As a result, printed image quality may be deteriorated by defects of the nozzle meniscus. Therefore, in the inkjet printer, an ejection surface of the head is wiped by a wiper in order, for example, to adjust the nozzle meniscus and to clean the ejection surface of the head.

The ejection surface of the head is wiped by the wiper in such a manner that, for example, a wiper having a blade shape elongated in a direction orthogonal to a scanning direction of the head (carriage) is fixed, and scanning of the head is performed while an upper surface or an upper edge of the wiper is brought into contact with the ejection surface. The ink adheres to the upper surface and an upper portion of the wiper having wiped the ejection surface of the head. If the wiper in that state wipes the ejection surface again, the ink adhering to the wiper again adheres to the ejection surface. Therefore, an absorber such as a sponge is brought into contact with the upper surface or the upper portion of the wiper, and the adhering ink is absorbed to the absorber to remove the wiper ink. For example, in JP-A-2017-149159, a wiper is moved in a longitudinal orthogonal direction while an upper surface or an upper edge of the wiper is brought into contact with an absorber, to remove wiper ink.

### SUMMARY OF THE INVENTION

In the method of removing the wiper ink disclosed in JP-A-2017-149159, the wiper is rubbed against the absorber. Therefore, the absorber and the wiper are abraded, and abrasion powder thereof adheres to the head ejection surface through the wiper when the head ejection surface is wiped. This may adversely affect ejection of ink droplets, namely, printing.

Example embodiments of the present invention provide inkjet printers each including a wiper for wipe a head ejection surface that can reduce abrasion of an absorber and a wiper with removal of wiper ink as much as possible and can prevent adverse effects caused by abrasion powder thereof.

An inkjet printer according to an example embodiment of the present invention includes a head to eject ink from an ejection port on a lower surface, a wiper to wipe an ejection surface, a wiper moving mechanism to move the wiper to a wiping position of the ejection surface and a standby position separated from the lower surface of the head, a lifting mechanism to lift and lower the wiper at both of the wiping position and the standby position, and an absorber held at a position at least above the standby position by an absorber holder at the standby position or in a vicinity of the standby position, and operable to, when an upper surface of the wiper is brought into contact with the absorber in a state where the wiper is moved to the standby position by the wiper moving mechanism and is lifted by the lifting mechanism, absorb and remove wiper ink adhering to the upper surface of the wiper.

According to the configuration, when the wiper at the standby position is lifted by the lifting mechanism, the upper surface of the wiper is brought into contact with the absorber that is held by the absorber holder and is above the standby position, the wiper ink adhering to the upper surface of the wiper is absorbed by the absorber and removed. At this time, the wiper and the absorber are brought into contact with and are separated from each other only by the lifting operation of the wiper, namely, are not rubbed against each other. Thus, abrasion of the wiper and the absorber can be reduced as much as possible. As a result, adverse effects caused by abrasion powder of the wiper and the absorber can be prevented.

As described above, according to example embodiments of the present invention, abrasion of the wiper and the absorber when the wiper ink is wiped can be reduced as much as possible, and adverse effects caused by abrasion powder of the wiper and the absorber can also be prevented. As a result, an operating rate of the inkjet printer can be improved, and printed image quality can also be improved.

The above and other elements, features, steps, characteristics and advantages of the present invention will become more apparent from the following detailed description of the example embodiments with reference to the attached drawings.

### BRIEF DESCRIPTION OF THE DRAWINGS

FIGS. 1A and 1B are schematic configuration diagrams illustrating a layout of main units of a large inkjet printer that is one example embodiment of an inkjet printer according to the present invention.

FIG. 2 is an explanatory diagram of a method of wiping wiper ink in the inkjet printer in FIGS. 1A and 1B.

FIG. 3 is a perspective view illustrating a schematic configuration of a lifting mechanism in the inkjet printer in FIGS. 1A and 1B.

FIG. 4 is an explanatory diagram of cams of the lifting mechanism in FIG. 3.

FIG. 5 is an explanatory diagram of lifting and lowering of caps by the cams in FIG. 4.

FIG. 6 is an explanatory diagram of lifting and lowering of a wiper by the cams in FIG. 4.

FIG. 7 is a detailed explanatory diagram of a wiper moving mechanism in the inkjet printer in FIGS. 1A and 1B.

FIG. 8 is a perspective view of an absorber holder in the inkjet printer in FIGS. 1A and 1B.

FIG. 9 is a plan view of the absorber holder in FIG. 8.

FIG. 10 is a perspective view of an ink receiving container and a movable ink receiving container in the inkjet printer in FIGS. 1A and 1B.

FIG. 11 is a partial cross-sectional side view illustrating arrangement of the ink receiving container and the movable ink receiving container in FIG. 10 when the movable ink receiving container is lowered.

### DETAILED DESCRIPTION OF THE EXAMPLE EMBODIMENTS

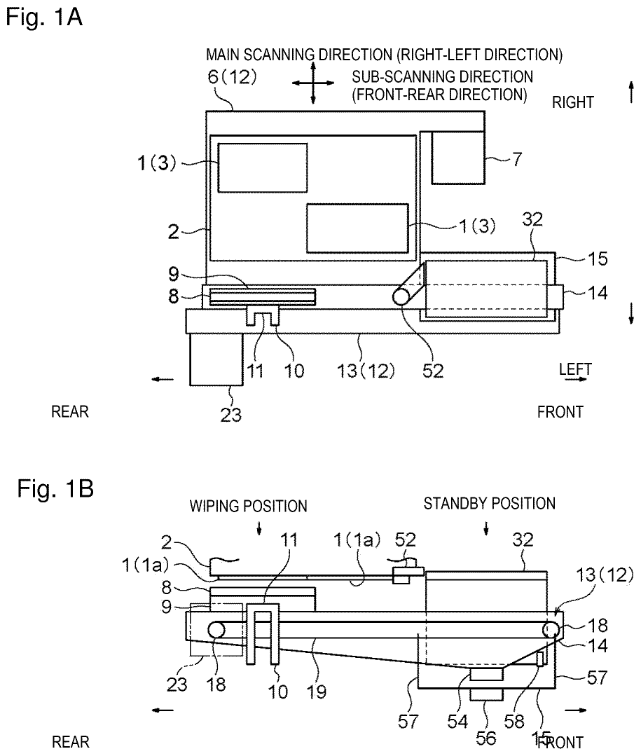

Example embodiments of inkjet printers according to the present invention are described in detail below with reference to drawings. FIGS. 1A and 1B are schematic configuration diagrams illustrating a layout of main units of a large inkjet printer to which the inkjet printer according to the present example embodiment is applied. The large inkjet printer has a configuration equivalent to a configuration disclosed in, for example, JP-A-2020-131609. Therefore, an entire configuration diagram is omitted. The inkjet printer includes an operation panel for a user to perform operation relating to printing, a cover covering a main body supported by leg portions, and the like on an upper surface of the main body. Further, a discharge port to discharge a medium (printing medium) is provided on a front surface of the main body, and a guide to guide the medium is provided on a lower front side of the discharge port.

In the inkjet printer, for example, a series of rolled sheet-shaped medium is fed onto a platen, printing is performed by ejecting ink to an upper surface of the medium on the platen, and then, the medium is discharged to the guide from the discharge port. As described below, heads 1 disposed above the platen and ejecting the ink are mounted on a carriage 2, the carriage 2 reciprocates in a direction intersecting a feeding direction of the medium, and the ink is ejected from the heads 1 while the carriage 2 intersects the medium. A reciprocation (scanning) direction of the heads 1 is a main scanning direction, and the feeding direction (including opposite direction) of the medium is a sub-scanning direction. Note that the material of the medium may be a resin sheet in addition to recording paper as long as the medium has a sheet shape. Further, it is unnecessary to continuously feed the sheet-shaped medium, and for example, the sheet-shaped medium may be a sheet material singularly disposed on the platen.

FIG. 1A is a plan view illustrating schematic layout of the main units of the inkjet printer, and FIG. 1B is a left side view thereof. In this example, a right side in the drawing is defined as a front side of the inkjet printer, and a left side is defined as a rear side of the inkjet printer. Therefore, FIG. 1B is a left side view. In the following, description is given based on these directions (therefore, directions may be different from illustrated directions). The inkjet printer according to the present example embodiment includes two heads 1 on a lower surface of the carriage 2. As described above, the medium is moved in the sub-scanning direction from the rear side to the front side of the printer while the carriage 2 including the heads 1 is reciprocated in the main scanning direction, namely, in a right-left direction of the printer. During reciprocation of the heads 1 in the main scanning direction, extremely small ink droplets are ejected from each of a plurality of (a lot of) ejection ports provided on lower surfaces of the heads 1, and the ink droplets are caused to land on the upper surface of the medium, thereby performing printing. On the lower surfaces of the heads 1, portions provided with the ejection ports are also referred to as ejection surfaces 1a. Note that positions of the heads 1 illustrated in FIG. 1A are original positions in a printer standby state as described below, and are different from positions in printing.

Caps 3 (see FIG. 5) joined to cover the respective ejection surfaces 1a of the heads 1 are disposed below the heads 1 at the original positions in the printer standby state illustrated in FIG. 1A. These caps 3 are to moisturize (to prevent drying of) the ejection ports and to forcibly suction the ink from the ejection ports while covering the ejection surfaces 1a of the heads 1. The two caps 3 covering the ejection surfaces 1a of the two heads 1 are mounted on a common support plate 5 (see FIG. 5). When the carriage 2 mounted with the heads 1 is moved to a position illustrated in FIG. 1A, the two caps 3 are separated downward from the ejection surfaces 1a of the heads 1. From the state, the two caps 3 are lifted together with the support plate 5 by a lifting mechanism 6 illustrated in FIG. 1A, and are brought into contact with the ejection surfaces 1a of the two heads 1 to cover the respective ejection surfaces 1a. At startup of the printer, the two caps 3 are lowered together with the support plate 5 and are separated from the ejection surfaces 1a of the heads 1, and in the state, the two heads 1 are moved together with the carriage 2 to a printing position. In the present example embodiment, the configurations and the functions of the heads 1, the carriage 2, the caps 3, and the like are not important. Therefore, detailed description thereof is omitted. The lifting mechanism 6 lifting and lowering the caps 3 also serves as the lifting mechanism 6 lifting and lowering a wiper 8 described below (together with movable ink receiving container 14, etc., in terms of structure). Thus, the lifting mechanism 6 and a wiper moving mechanism 13 described below configure a wiper driving mechanism 12. Details of the lifting mechanism 6 are described below. The lifting mechanism 6 is rotationally driven by a lifting motor 7.

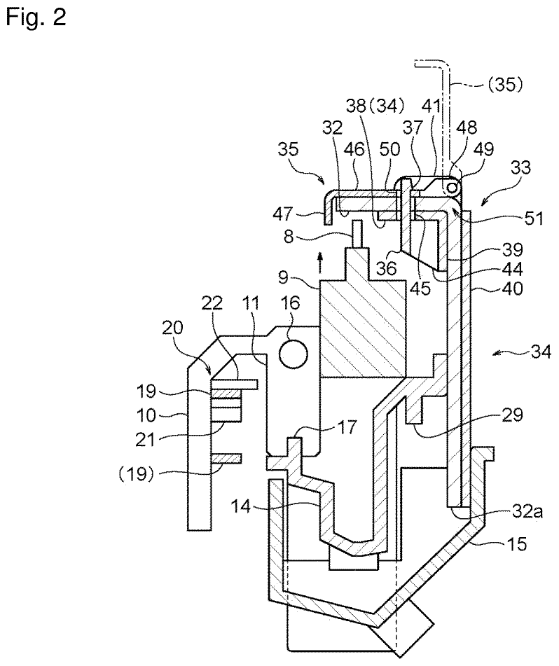

The wiper 8 wiping the ejection surfaces la of the heads 1 is held by a wiper holder 9, and the wiper holder 9 is housed in the movable ink receiving container 14 elongated in a front-rear direction (see FIG. 2). In a case where the ejection surfaces 1a of the heads 1 are wiped, the wiper 8 is fixed to a position illustrated in FIG. 1A, the heads 1 are scanned (moved) in the main scanning (right-left) direction while an upper surface (upper edge) of the wiper 8 is in contact with the ejection surfaces 1a of the heads 1, and accordingly the ink and the like adhering to the ejection surfaces 1a are wiped. In the present example embodiment, the wiper 8 is made of a material having both of flexibility and strength, and has a blade shape elongated in the front-rear direction and thin in the right-left direction. The wiper 8 is disposed such that the upper surface (upper edge) is parallel or substantially parallel to the ejection surfaces 1a of the heads 1. The wiper holder 9 holding the wiper 8 is also elongated in the front-rear direction, and holds the wiper 8 such that the wiper 8 protrudes upward from a holder upper surface. As viewed from the front side, an arm base end portion 11 is integrally provided on a left side surface of the wiper holder 9, and an arm portion 10 that protrudes leftward and extends downward from the arm base end portion 11 is integrally provided.

The movable ink receiving container 14 is also elongated in the front-rear direction. More specifically, the movable ink receiving container 14 communicates from a wiping position where the wiper 8 wipes the ejection surfaces 1a of the heads 1, namely, the position illustrated in FIG. 1A to a position where an absorber 32 described below is disposed, namely, a standby position. In other words, the wiping position and the standby position are separated away in a printer front-rear direction. In the present example embodiment, the wiper 8 and the wiper holder 9 are reciprocated from the wiping position to the standby position by a wiper moving mechanism 13 described below, and the movable ink receiving container 14 communicates from the wiping position to the standby position in order to house the wiper holder 9 during the reciprocation. Further, an upper portion of the movable ink receiving container 14 is opened to enable the reciprocation of the wiper 8 and the wiper holder 9 in a state where upper portions of the wiper 8 and the wiper holder 9 protrude upward such that a cleaning liquid dripping from a cleaning liquid nozzle 52 described below drips off onto the upper surface of the wiper 8. A guide 16 (see FIG. 2) including a series of round bar extending in the front-rear direction is integrally provided on an upper left side of the movable ink receiving container 14 as viewed from the front side. The guide 16 is slidably inserted into the arm base end portion 11 of the wiper holder 9, and a concave portion 17 at a lower end portion of the arm base end portion 11 engages with an upper left edge portion of the movable ink receiving container 14. As a result, the wiper 8 (wiper holder 9) is reciprocated in the front-rear direction while the positions of the wiper holder 9 and the wiper 8 in a vertical direction and the right-left direction relative to the movable ink receiving container 14 are regulated. In the movable ink receiving container 14 illustrated in FIG. 2, a lower surface of a plate-shaped edge portion elongated in the front-rear direction, protruding downward from a surface of the wiper holder 9 on a side opposite to the arm base end portion 11 side, namely, a right side surface as viewed from the front side configures a cam contact surface 29 for wiper cams 30 of the lifting mechanism 6 described below, namely, a cam follower. Further, an individual fixed ink receiving container 15 is disposed below the movable ink receiving container 14 at the standby position, and details thereof are described below.

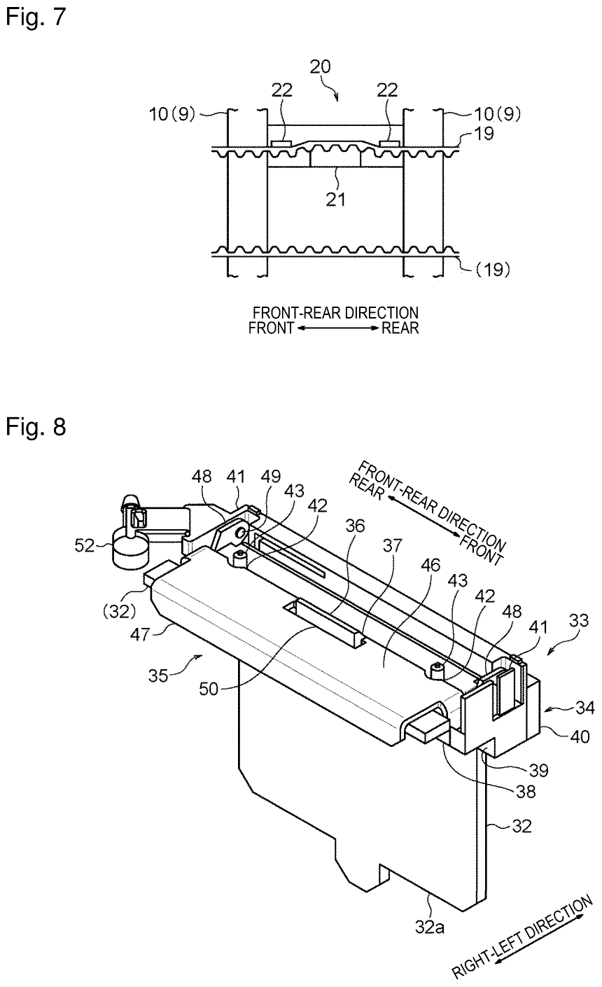

As described above, the wiper 8 and the wiper holder 9 are moved from the wiping position to the standby position by the wiper moving mechanism 13. As briefly illustrated in FIG. 1B, the wiper moving mechanism 13 includes pullies 18 and a belt 19. As illustrated in the drawing, the two pullies 18 in pair are provided at a rear side of the wiping position of the wiper 8 and a front side of the standby position of the wiper 8. The belt 19 wound around the two pullies 18 is, for example, a timing belt as illustrated in FIG. 7. As illustrated in FIG. 2, the belt 19 is inserted between the arm portion 10 and the arm base end portion 11 of the wiper holder 9, and an upper side portion of the wound belt 19 engages with a belt engagement portion 20 provided on the arm base end portion 11 side of the arm portion 10. FIG. 7 is a diagram illustrating the belt 19 and the belt engagement portion 20 as viewed from the arm base end portion 11 side (namely, right side). The belt engagement portion 20 includes a belt receiving portion 21 including, on an upper surface, a teeth portion meshing with teeth of the timing belt 19, and two belt pressing portions 22 in pair provided slightly above the belt receiving portion 21 on both sides of the belt receiving portion 21 in the front-rear direction.

In other words, the teeth on an inner peripheral surface of the upper side portion of the wound timing belt 19 meshes with the teeth portion of the belt receiving portion 21, and the upper side portion of the wound timing belt 19 is pressed toward the belt receiving portion 21 by the belt pressing portions 22 on both sides of the meshing portion. As described above, in the present example embodiment, the movable ink receiving container 14 is lifted and lowered together with the wiper holder 9 and the wiper 8 by the lifting mechanism 6. In particular, when the wiper 8 and the movable ink receiving container 14 are lifted, the engagement portion of the belt 19 engaging with the arm portion 10 of the wiper holder 9 is lifted with lifting of the wiper holder 9; however, the belt 19 is not cut and deteriorated because the belt 19 is made of a rubber and has high stretchability. In addition, during lifting, the teeth on the inner peripheral surface of the belt 19 and the teeth portion of the belt receiving portion 21 of the arm portion 10 mesh with each other while the upper side portion of the belt 19 is pressed toward the belt receiving portion 21 by the belt pressing portions 22. Therefore, the arm portion 10 and the belt 19 are not disengaged. The wiper holder 9 and the upper side portion of the belt 19 engaging with the wiper holder 9 are lifted from, for example, the state illustrated in FIG. 2. Thus, a lower side portion of the belt 19 is relatively lowered. At this time, a surface of the arm portion 10 of the wiper holder 9 on the arm base end portion 11 side (right side) serves as a guide, and prevents the belt 19 from being damaged due to, for example, repetitive abutment of a corner of a lower end portion of the arm portion 10 on the belt 19. In the present example embodiment, the pulley 18 on the left side in FIG. 1B is rotationally driven by a reciprocation motor 23. The arm portion 10 of the wiper holder 9 is configured to block an optical path of a photo-interrupter 58 (see FIG. 1B) provided at the standby position of the wiper 8. In a case where the optical path of the photo-interrupter 58 is blocked, it is determined that the wiper 8 is at the standby position.

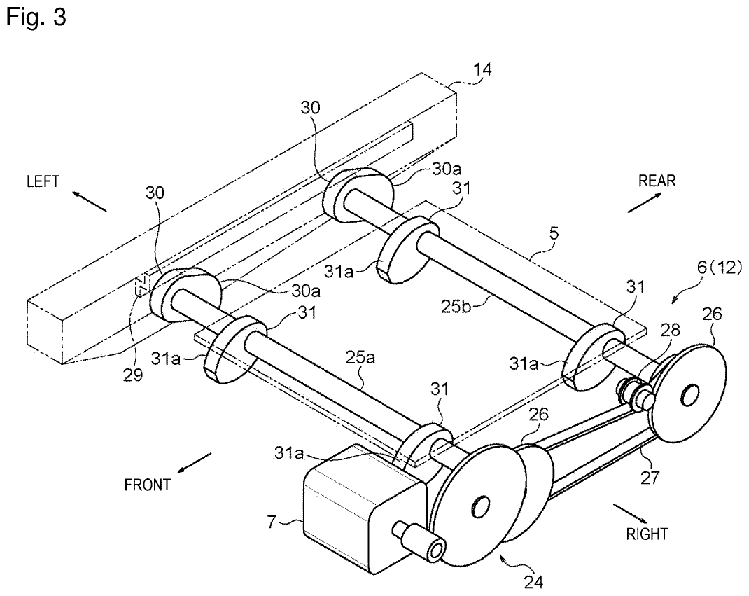

FIG. 3 is a perspective view illustrating a schematic configuration of the lifting mechanism 6 lifting and lowering the caps 3 and the wiper 8 in the inkjet printer according to the present example embodiment. Rotational driving force of the lifting motor 7 is transmitted to a first cam shaft 25a extending in the right-left direction, through a reduction gear mechanism 24. A second cam shaft 25b is parallel or substantially parallel to the first cam shaft 25a in the front-rear direction. A pulley 26 is attached to each of the first cam shaft 25a and the second cam shaft 25b. A belt 27 is wound around the pullies 26, which synchronously rotates the first cam shaft 25a and the second cam shaft 25b. A tensioner 28 is pushed against an outer peripheral surface of the wound belt 27 to apply predetermined tension to the belt 27. One wiper cam 30 to be brought into contact with the cam contact surface 29 of the movable ink receiving container 14 is attached to a left end portion of each of the two cam shafts 25a and 25b. One cap cam 31 is attached to each of a right part and a left portion close to a center of each of the cam shafts 25a and 25b, namely, two cap cams 31 are attached to each of the cam shafts 25a and 25b. The cap cams 31 are in contact with a lower surface of the support plate 5 on which the caps 3 are mounted.

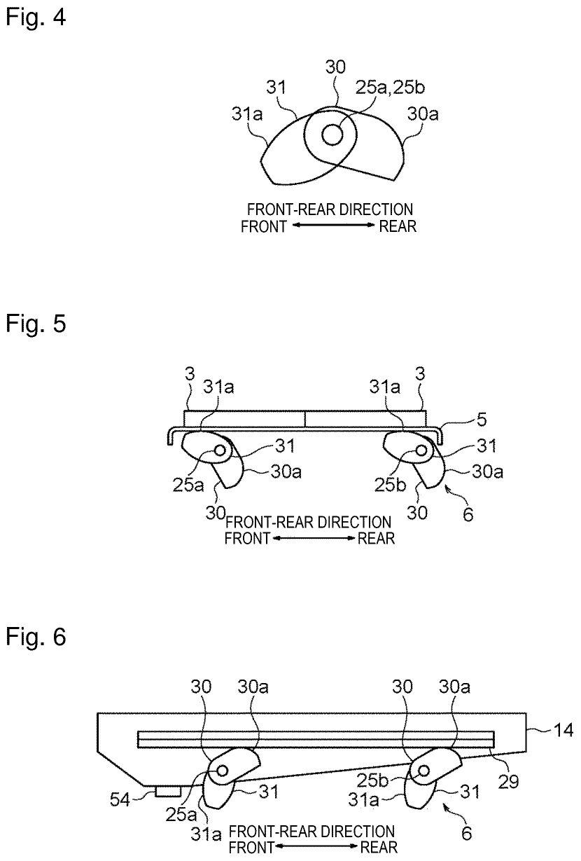

FIG. 4 illustrates an arrangement state when the cap cams 31 and the wiper cam 30 attached to each of the cam shafts 25a and 25b are at original positions on the cam shafts. Each of the cap cams 31 includes a cam nose 31A on the front side, and each of the wiper cams 30 includes a cam nose 30a on the rear side. Therefore, when the cam shafts 25a and 25b are rotated in a clockwise direction in the drawing, the caps 3 are lifted together with the support plate 5 by the cam noses 31a of the cap cams 31 as illustrated in FIG. 5. When the cam shafts 25a and 25b are rotated in a counterclockwise direction in the drawing, the movable ink receiving container 14 is lifted by the cam noses 30a of the wiper cams 30 as illustrated in FIG. 6. As described above, when the caps 3 are lifted while the heads 1 are at the standby position, the ejection surfaces 1a of the heads 1 are covered with the caps 3. When the wiper 8 at the wiping position is lifted while the heads 1 are at the printing position, the upper surface or the upper edge of the wiper 8 is brought into contact with the ejection surfaces 1a of the heads 1. Further, in the present example embodiment, as described below, the wiper 8 is configured to be lifted by the lifting mechanism 6 even in the state where the wiper 8 is at the standby position. The wiper ink is removed by bringing the upper surface of the wiper 8 into contact with the absorber 32. As described above, when the lifting mechanism 6 is used for the caps 3 and the wiper 8, only one lifting motor 7 is needed, which makes it possible to simplify the configuration and to reduce the cost.

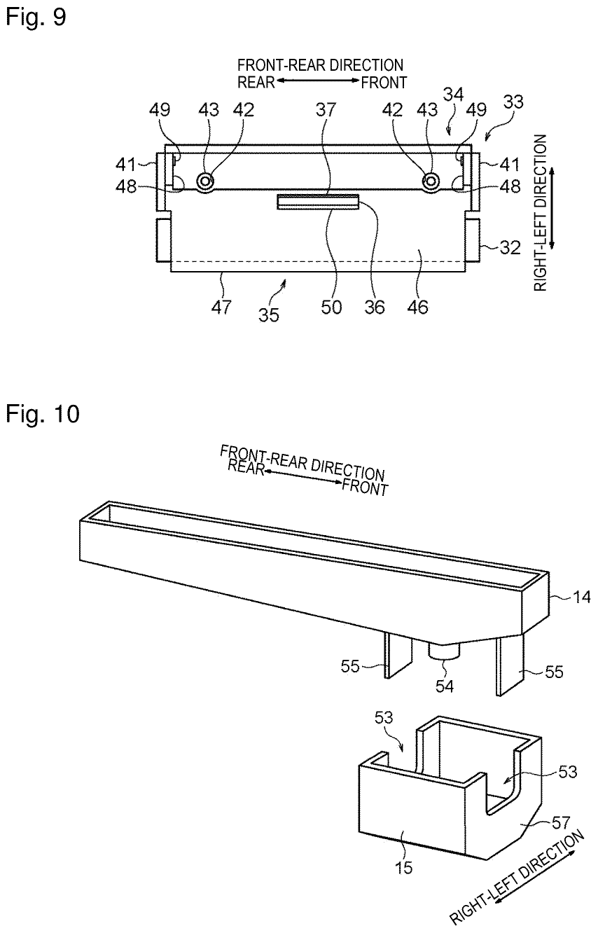

FIG. 2 illustrates a cross-section in a state where the wiper 8 and the wiper holder 9 are at the standby position. As described above and as described in detail below, the fixed ink receiving container 15 is disposed below the standby position, and a lower portion of the movable ink receiving container 14 enters the fixed ink receiving container 15 when the movable ink receiving container 14 is lowered. On the other hand, the absorber 32 that absorbs and removes the wiper ink adhering to the wiper 8 is disposed above the standby position. The absorber 32 includes a sponge made of a polyolefin resin in a sheet shape, and is disposed so as to be deployed in a horizontal direction above the wiper 8 at the standby position in a state of being held by an absorber holder 33. FIG. 8 is a perspective view of the absorber holder 33 in a state of holding the absorber 32, and FIG. 9 is a plan view thereof. The absorber holder 33 mainly includes a receiver 34 supporting a lower surface of the sheet-shaped absorber 32 deployed in the horizontal direction above the wiper 8, and a lid 35 that is openably/closably attached to the receiver 34 and covers, in a closed state, an upper surface of the sheet-shaped absorber 32 deployed in the horizontal direction. In other words, the sheet-shaped absorber 32 deployed in the horizontal direction above the wiper 8 is sandwiched between the receiver 34 and the lid 35.

As understood from FIG. 2, the lower surface of the sheet-shaped absorber 32 deployed in the horizontal direction is released above the wiper 8 at the standby position. In other words, the lower surface of the absorber 32 is not supported by the receiver 34 above the wiper 8. Accordingly, when the wiper 8 is lifted by the lifting mechanism 6 at the standby position, the upper surface (including upper edge) of the wiper 8 is brought into contact with the lower surface of the absorber 32 over an entire region in a longitudinal direction, and adhesion wiper ink is absorbed to the absorber 32 and removed. As results of various experiments, when pressing force by the lifting mechanism 6 pressing the wiper 8 against the absorber 32 at this time is set to about 3.5 N or more, for example, the wiper ink can be surely absorbed to the absorber 32 including the polyolefin resin sponge and removed. To receive the pressing force, the upper surface of the sheet-shaped absorber 32 deployed in the horizontal direction is covered with the lid 35 made of a metal in a region where the wiper 8 is pressed from below. As described below, the lid 35 engages with a claw portion 37 of an engagement portion 36 provided on the receiver 34, and is not easily detached (moved) even when the wiper 8 is pressed against the absorber 32 from below.

The receiver 34 is integrally made of a resin material having predetermined elasticity, and mainly includes a plate-shaped supporting portion 38 supporting the lower surface of the sheet-shaped absorber 32 deployed in the horizontal direction, a plate-shaped guide portion 39 extending downward from a right end portion of the supporting portion 38, a plate-shaped rear plate portion 40 separated rightward from the guide portion 39 at a predetermined interval and extending downward from the supporting portion 38 in parallel to the guide portion 39, and wall portions 41 protruding upward from both ends of the supporting portion 38 in the front-rear direction. Cylindrical portions 43 to be inserted into circular holes 42 provided in the sheet-shaped absorber 32 protrude at both end portions in the front-rear direction on an upper surface of the supporting portion 38. Further, the plate-shaped engagement portion 36 that is elongated in the front-rear direction and protrudes upward is provided on a rib 44 protruding leftward from the guide portion 39. The engagement portion 36 extends upward through a slit-shaped through hole 45 elongated in the front-rear direction, provided on the supporting portion 38, and the claw portion 37 engaging with an upper surface of the lid 35 in the closed state protrudes from a right side surface of an upper end portion of the engagement portion 36.

The lid 35 is integrally made of a metal material having predetermined rigidity, and mainly includes a plate-shaped lid portion 46 that covers and presses the upper surface of the sheet-shaped absorber 32 deployed in the horizontal direction, a plate-shaped handle portion 47 extending downward from a left end portion of the lid portion 46, and coupling portions 48 protruding rightward from both end portions of the lid portion 46 in the front-rear direction. The coupling portions 48 of the lid 35 are positioned on inside in the front-rear direction relative to the respective wall portions 41 of the receiver 34, and a rotation shaft 49 is inserted into each of the coupling portions 48 and the corresponding wall portion 41 of the receiver 34. Accordingly, the lid 35 is pivotable from an absorber sandwiching position (closed position) illustrated by a solid line in FIG. 2 to an open position illustrated by an alternate long and two short dashes line in FIG. 2, thereby being attached so as to be openable and closable relative to the receiver 34. Further, the lid 35 includes a slit 50 that is elongated in the front-rear direction and into which the claw portion 37 of the engagement portion 36 is insertable, at a position facing the engagement portion 36 of the receiver 34 in the closed state. Accordingly, when the lid 35 in an open state pivots to the closed position and is closed while the absorber 32 is mounted on the supporting portion 38 of the receiver 34, the claw portion 37 provided at the upper end portion of the engagement portion 36 passes through the slit 50 of the lid 35 while the engagement portion 36 is elastically deformed, the claw portion 37 further covers the upper surface of the lid portion 46 of the lid 35 by elastic restoring force of the engagement portion 36, and the claw portion 37 engages with the upper surface of the lid 35 to prevent the lid 35 from being opened when the wiper is pressed. Note that, to open the lid 35, the engagement portion 36 is pushed in a direction opposite to the protruding direction of the claw portion 37 to disengage the claw portion 37 from the lid 35, and hand fingers are hooked to the handle portion 47 in the state to open the lid 35.

A slit-shaped insertion hole portion 51 elongated in the front-rear direction is provided between the guide portion 39 and the rear plate portion 40 of the receiver 34, and an end portion 32a of the sheet-shaped absorber 32 on a side opposite to the wiper side (contact region with wiper 8) is inserted into the insertion hole portion 51. The end portion 32a of the absorber 32 on the side opposite to the wiper side passes through a gap between the rear plate portion 40 of the receiver 34 and the movable ink receiving container 14 along the rear plate portion 40, and is further suspended down into the fixed ink receiving container 15. Therefore, the wiper ink absorbed into the absorber 32 in the contact region with the wiper 8, namely, at the upper left part in FIG. 2 is gradually infiltrated and dispersed inside the absorber 32 toward the end portion 32a on the opposite side, and finally reaches the end portion 32a on the opposite side. Thus, when the end portion 32a of the absorber 32 on the side opposite to the contact region with the wiper 8 is suspended down into the fixed ink receiving container 15, if the absorbed wiper ink drips from the end portion 32a on the opposite side, the dripping ink can be received by the fixed ink receiving container 15, which makes it possible to prevent the dripping ink from being leaked to inside and outside of the printer.

The cleaning liquid nozzle 52 illustrated in FIGS. 1A and 1B is attached to an upper portion of the receiver 34 of the absorber holder 33. The cleaning liquid nozzle 52 protrudes obliquely left rearward from the receiver 34, and a protruding front-end portion thereof is disposed so as to face the upper surface of the wiper 8 moved in the front-rear direction inside the movable ink receiving container 14. Further, a cleaning liquid is supplied to the cleaning liquid nozzle 52 through an unillustrated tube, and the cleaning liquid drips from a lower surface of the protruding front-end portion of the cleaning liquid nozzle 52. In the present example embodiment, the wiper 8 is normally at the standby position, and is moved toward the wiping position to wipe the ejection surfaces 1a of the heads 1. During the movement, the cleaning liquid drips from above by the cleaning liquid nozzle 52 while the wiper 8 is moved in the front-rear direction (in particular, rearward) in the middle of the path of the wiper 8. As a result, for example, the wiper ink not absorbed to the absorber 32 at a portion other than the upper surface (upper edge) of the wiper 8 can be washed away. In addition, the cleaning liquid is caused to adhere to the upper surface (upper edge) of the wiper 8, which makes it possible to surely perform next wiping of the ejection surfaces 1a of the heads 1. The wiper ink washed away by the cleaning liquid drips/flows down into the movable ink receiving container 14. This makes it possible to prevent the wiper ink from being leaked to the inside and the outside of the printer.

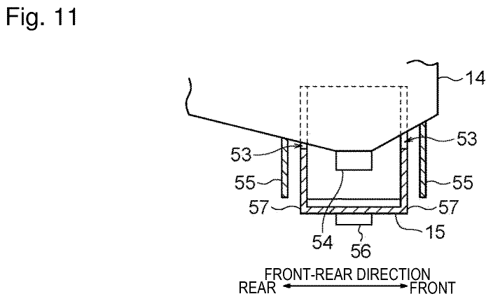

FIG. 10 is a perspective view illustrating a state where the fixed ink receiving container 15 and the movable ink receiving container 14 are vertically separated, and FIG. 11 is a partial cross-sectional side view illustrating arrangement of the movable ink receiving container 14 and the ink receiving container 15 when the movable ink receiving container 14 is lowered. The movable ink receiving container 14 elongated in the front-rear direction has a width narrow in the right-left direction in FIG. 1B. On the other hand, the fixed ink receiving container 15 disposed only at the wiper standby position is relatively short in the front-rear direction but has a width wide in the right-left direction. In the present example embodiment, as described above, a portion of the movable ink receiving container 14 enters the upper portion of the fixed ink receiving container 15 when the movable ink receiving container 14 is lowered. Accordingly, wall portions 57 of the fixed ink receiving container 15 in the front-rear direction each have a concave portion 53 into which the movable ink receiving container 14 enters. An ink discharge port 54 is provided on a bottom surface of a portion of the movable ink receiving container 14 entering the fixed ink receiving container 15, and a bottom surface of the movable ink receiving container 14 has drainage slope by being inclined so as to be gradually lowered from the front side and the rear side toward the portion provided with the ink discharge port 54.

On the bottom surface of the movable ink receiving container 14, plate-shaped anti-scattering wall portions 55 protruding downward at positions outside the respective concave portions 53 of the wall portions 57 of the fixed ink receiving container 15 in the front-rear direction are provided. Therefore, the concave portions 53 of the wall portions 57 of the fixed ink receiving container 15 in the front-rear direction are covered with the respective anti-scattering wall portions 55 of the movable ink receiving container 14. As a result, as described above, when the ink (including cleaning liquid) dripping/flowing down into the movable receiving container 14 is discharged from the ink discharge port 54 into the fixed ink receiving container 15, scattering of the ink is prevented by the wall portions 57 of the fixed ink receiving container 15 in the front-rear direction and the anti-scattering wall portions 55 of the movable ink receiving container 14. Note that an ink discharge port 56 is provided on a bottom surface of the fixed ink receiving container 15, and the ink discharge port 56 is connected to an unillustrated waste ink tank.

As described above, in the inkjet printer according to the present example embodiment, when the wiper 8 at the standby position is lifted by the wiper driving mechanism 12, the upper surface of the wiper 8 is brought into contact with the absorber 32 disposed above the standby position, and the wiper ink adhering to the upper surface of the wiper 8 is absorbed by the absorber 32 and removed. At this time, the wiper 8 and the absorber 32 are brought into contact with and separated from each other only by the lifting operation of the wiper 8, namely, are not rubbed against each other. Thus, abrasion of the wiper 8 and the absorber 32 can be reduced as much as possible. As a result, adverse effects caused by abrasion powder of the wiper 8 and the absorber 32 can be prevented.

Since the absorber 32 includes the polyolefin resin sponge, the wiper ink adhering to the wiper 8 is rapidly absorbed.

In addition, when the wiper 8 is pressed against the absorber 32 including the polyolefin resin sponge with the pressing force of about 3.5 N or more, for example, the wiper ink adhering to the wiper 8 is surely absorbed, and the wiper 8 is cleaned.

The lower surface of the sheet-shaped absorber 32 deployed in the horizontal direction above the standby position is supported by the receiver 34 in a region other than the contact region with the wiper 8, and the upper surface of the absorber 32 in the contact region with the wiper 8 is covered with the lid 35 openably/closably attached to the receiver 34. As a result, the receiver 34 and the lid 35 can sandwich the sheet-shaped absorber 32, and the upper surface of the wiper 8 can be firmly pressed against the absorber 32.

Further, since the end portion of the sheet-shaped absorber 32 on the side opposite to the contact region with the wiper is suspended down into the fixed ink receiving container 15 disposed below the absorber 32, the absorbed wiper ink can be received by the fixed ink receiving container 15, which makes it possible to prevent the wiper ink from being leaked to the inside and the outside of the printer.

The wiper holder 9 holding the wiper 8 is housed so as to be movable in the front-rear direction, namely, the container communicating direction, in the movable ink receiving container 14 that communicates from the wiping position to the standby position in the front-rear direction and has the opened upper portion, the wiper moving mechanism 13 moves the wiper holder 9 and the wiper 8 in the front-rear direction, namely, in the container communicating direction, and the lifting mechanism 6 lifts and lowers the movable ink receiving container 14 and the wiper 8. As a result, the wiper 8 can be lifted and lowered at the wiping position and the standby position, and the wiper ink dripping/flowing down from the wiper 8 can be received by the movable ink receiving container 14 when the wiper 8 is moved to the wiping position and the standby position, which makes it possible to prevent the wiper ink from being leaked to the inside and the outside of the printer.

Although inkjet printers according to the example embodiments are described above, the present invention is not limited to the configurations described in the above-described example embodiments, and can be variously modified within the spirit of the present invention. For example, in the above-described example embodiments, the absorber 32 preferably has a sheet shape. However, the absorber 32 may have a shape other than the sheet shape. However, to suspend a portion of the absorber 32 into the fixed ink receiving container 15 and to bring the upper surface of the wiper 8 into contact with the absorber 32 over the entire region as described above, the absorber 32 desirably has an elongated sheet shape.

Furthermore, the layouts of the main components of the inkjet printers according to the above-described example embodiments is illustrative, and can be appropriately changed and set depending on use application and specification.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-6. (canceled).

7. An inkjet printer comprising:
a head to eject ink from an ejection port on a lower surface;
a wiper to wipe an ejection surface of the head;
a wiper moving mechanism to move the wiper to a wiping position of the ejection surface and a standby position separated from the lower surface of the head;
a lifting mechanism to lift and lower the wiper at both of the wiping position and the standby position; and
an absorber held at a position at least above the standby position by an absorber holder at the standby position or in a vicinity of the standby position in order to, when an upper surface of the wiper is brought into contact with the absorber in a state where the wiper is moved to the standby position by the wiper moving mechanism and is lifted by the lifting mechanism, absorb and remove wiper ink adhering to the upper surface of the wiper.

8. The inkjet printer according to claim 7, wherein the absorber includes a polyolefin resin sponge.

9. The inkjet printer according to claim 8, wherein the wiper is pressed against the absorber with a pressing force of about 3.5 N or more by the lifting mechanism.

10. The inkjet printer according to claim 7, wherein
the absorber has a sheet shape, and is held by the absorber holder to be deployed at least above the standby position; and
the absorber holder includes a receiver to support a lower surface of the absorber deployed in a horizontal direction, in a region other than a contact region with the wiper, and a lid openably/closably attached to the receiver and operable to cover an upper surface of the absorber at least in the contact region with the wiper.

11. The inkjet printer according to claim 10, wherein
an ink receiving container including an opened upper portion below the absorber; and
an end portion of the absorber having the sheet shape on a side opposite to the contact region with the wiper is suspended down into the ink receiving container.

12. The inkjet printer according to claim 7, further comprising:
a movable ink receiving container to communicate from the wiping position to the standby position, including an opened upper portion, and operable to be lifted and lowered by the lifting mechanism; and
a wiper holder housed in the movable ink receiving container to be movable in a communication direction of the movable ink receiving container and to hold the wiper; wherein
the wiper moving mechanism is operable to move the wiper between the wiping position and the standby position by moving the wiper holder in the communication direction; and
the lifting mechanism is operable to lift and lower the wiper by lifting and lowering the movable ink receiving container.
